(19) United States
(12) Patent Application Publication
(10) Pub. No.: US 2026/0059058 A1
(43) Pub. Date: Feb. 26, 2026

(54) INFORMATION PROCESSING APPARATUS, CONTROL METHOD THEREOF, AND STORAGE MEDIUM

(71) Applicant: CANON KABUSHIKI KAISHA, Tokyo (JP)

(72) Inventor: YOSHIHIRO TSUKADA, Ibaraki (JP)

(21) Appl. No.: 19/298,566

(22) Filed: Aug. 13, 2025

(30) Foreign Application Priority Data
Aug. 26, 2024 (JP) 2024-144466

(51) Int. Cl. H04N 1/00; G06F 3/04817; G06F 3/0482

(52) U.S. Cl. CPC H04N 1/00413; G06F 3/04817; G06F 3/0482

(57) ABSTRACT

The present disclosure is directed to an information processing apparatus comprising: one or more memory devices that store a set of instructions; and one or more processors that execute the set of instructions to: acquire an information list including a plurality of parameters relating to a user; display, on a display unit, a user interface for generating an icon image that identifies a user; select one or more parameters of the plurality of parameters in accordance with a user input via the user interface; transmit the one or more selected parameters to an external server to acquire one or more icon images; and present the one or more acquired icon images to the user interface.

### BACKGROUND

### Field of the Technology

The present disclosure relates to an information processing apparatus that supports creation of a user icon, a control method thereof, and a storage medium.

### DESCRIPTION OF THE RELATED ART

Japanese Patent Laid-Open No. 2022-13620 proposes a mechanism that can easily specify information on a communication tool only by selecting a registered object with an image forming apparatus. The object as described above includes an icon image for identifying the user on the communication tool, for example.

However, when the user registers an icon image such as the object described above on a communication tool disclosed on the Internet, there are the following problems. For example, when information is identified based on an icon image as in the known technique described above, the icon image needs to be able to specify a target. However, creation of such an icon image needs work for the user to select and register an arbitrary image, which takes time and labor.

### SUMMARY

The present disclosure enables realization of a novel mechanism that easily generates an icon image relating to a user.

One aspect of the present disclosure provides an information processing apparatus comprising: one or more memory devices that store a set of instructions; and one or more processors that execute the set of instructions to: acquire an information list including a plurality of parameters relating to a user; display, on a display unit, a user interface for generating an icon image that identifies a user; select one or more parameters of the plurality of parameters in accordance with a user input via the user interface; transmit the one or more selected parameters to an external server to acquire one or more icon images; and present the one or more acquired icon images to the user interface.

Another aspect of the present disclosure provides a control method of an information processing apparatus, the control method comprising: acquiring an information list including a plurality of parameters relating to a user; displaying, on a display unit, a user interface for generating an icon image that identifies a user; selecting one or more parameters of the plurality of parameters in accordance with a user input via the user interface; transmitting the one or more selected parameters to an external server to acquire one or more icon images; and presenting the one or more acquired icon images to the user interface.

Still another aspect of the present disclosure provides a non-transitory computer-readable storage medium storing a computer program for causing a computer to execute each process in a control method of an information processing apparatus, the control method comprising: acquiring an information list including a plurality of parameters relating to a user; displaying, on a display unit, a user interface for generating an icon image that identifies a user; selecting one or more parameters of the plurality of parameters in accordance with a user input via the user interface; transmitting the one or more selected parameters to an external server to acquire one or more icon images; and presenting the one or more acquired icon images to the user interface.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view illustrating an example of a system configuration according to one embodiment.

FIG. 2 is a view illustrating an example of a hardware configuration of a multi function peripheral (MFP) 101 according to one embodiment.

FIG. 3 is a view illustrating an example of a hardware configuration of a mobile terminal 200 according to one embodiment.

FIG. 4 is a view illustrating an example of a hardware configuration of a message app server 300 according to one embodiment.

FIG. 5 is a view illustrating an example of a hardware configuration of an icon generation AI server 400 according to one embodiment.

FIG. 6 is a view illustrating an example of a sequence in the present system according to one embodiment.

FIG. 7 is a view illustrating tenant information managed by the message app server 300 according to one embodiment.

FIGS. 8A and 8B are views illustrating an example of parameters necessary for icon generation according to one embodiment and icon generation.

FIG. 9 is a view illustrating a screen example of an icon generation UI according to one embodiment.

FIG. 10 is a view illustrating a screen example in which an icon according to one embodiment is used.

FIG. 11 is a flowchart showing a process procedure of the MFP 101 according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### <System Configuration>

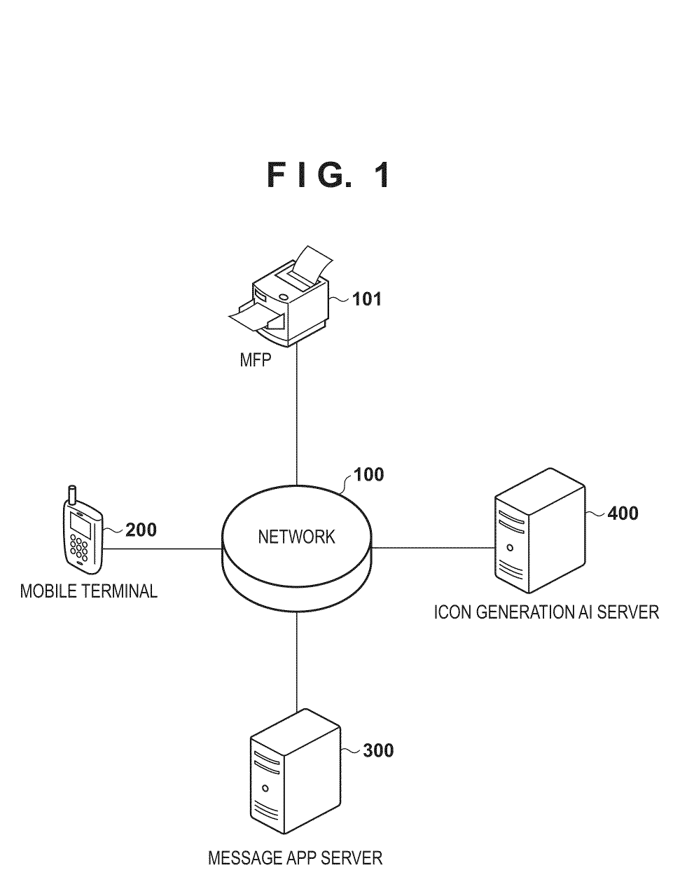

Hereinafter, one embodiment of the present disclosure will be described. An example of a system configuration according to the present embodiment will be described with reference to FIG. 1.

The system configuration according to the present embodiment is configured to include the MFP 101, the mobile terminal 200, the message app server 300, and the icon generation AI server 400. The mobile terminal 200 is an example of a terminal apparatus owned by a user who uses the present system. The MFP 101 is an information processing apparatus that can mutually communicate with each apparatus via a network 100. The message app server 300 and the icon generation AI server 400 are also connected via the network 100 and can mutually communicate with each apparatus. The message app server 300 and the icon generation AI server 400 are examples of external servers, and may be provided integrally.

The message app server 300 is a chat server that receives a message or image data transmitted from the MFP 101 or the mobile terminal 200 and manages a chat service displayed on the mobile terminal 200 or a PC (not illustrated) by a user operation. The icon generation AI server 400 associates information (token information) corresponding to a bot app installed in the message app server 300 to be connected to the MFP 101, and transfers, to the message app server 300, a request from the MFP 101. Note that the network 100 of the present embodiment may be the Internet or a local area network (LAN). The network 100 may be configured in a wired manner or in a wireless manner.

### <Hardware Configuration of Information Processing Apparatus (MFP)>

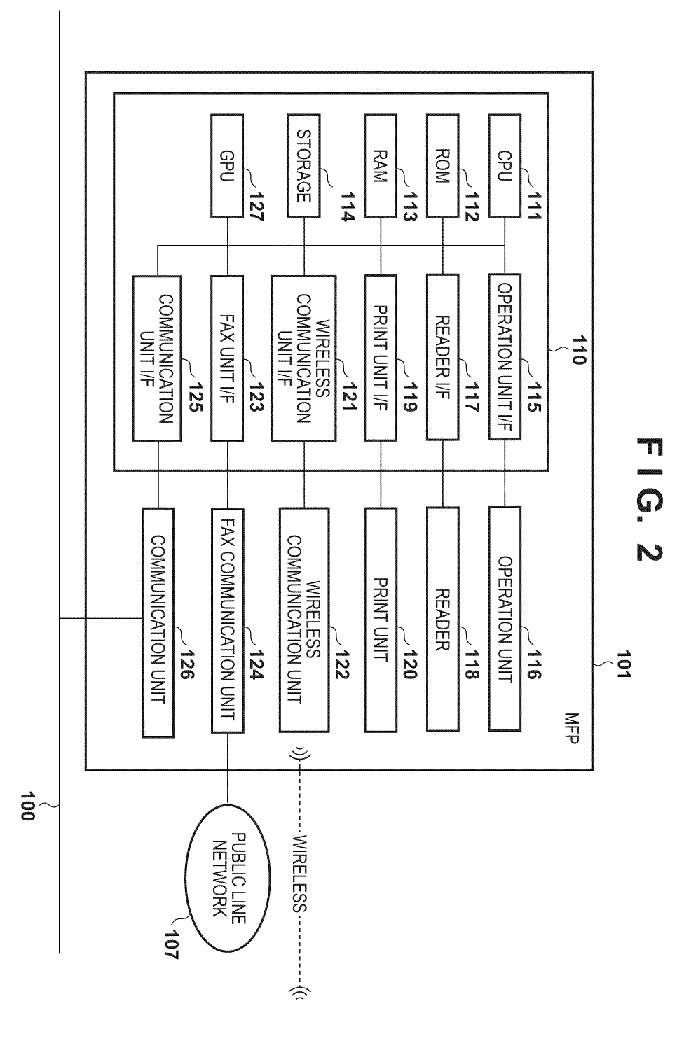

An example of the hardware configuration of the MFP 101 according to the present embodiment will be described with reference to FIG. 2. The MFP 101 is an example of an information processing apparatus, and includes a CPU 111, a ROM 112, a RAM 113, a storage 114, an operation unit I/F 115, an operation unit 116, a reader I/F 117, a reader 118, a print unit I/F 119, and a print unit 120. The MFP 101 further includes a wireless communication unit I/F 121, a wireless communication unit 122, a FAX unit I/F 123, a FAX communication unit 124, a communication unit I/F 125, a communication unit 126, and a GPU 127.

The control unit 110 including the CPU 111 controls the entire operation of the MFP 101. The CPU 111 reads, into the RAM 113, a control program stored in the ROM 112 or the storage 114, and performs various controls such as read control and print control. The ROM 112 stores a control program that can be executed in the CPU 111. The ROM 112 also stores a boot program, font data, and the like. The RAM 113 is a main storage memory, and is used as a temporary storage area for developing various control programs stored in a work area, the ROM 112, and the storage 114. The storage 114 stores image data, print data, various programs, and various pieces of setting information. The present embodiment assumes a flash memory as the storage 114, but may use an auxiliary storage apparatus such as a solid state drive (SSD) or a hard disk drive (HDD). An embedded Multi Media Card (eMMC) may be used.

Note that in the MFP 101 of the present embodiment, one CPU 111 executes each process shown in the flowchart described later using one memory (RAM 113), but is not limited to this. For example, each process shown in the flowchart to be described later can be executed by a plurality of CPUs, RAMs, ROMs, and storages in cooperation. Some processes may be executed using the GPU 127 and a hardware circuit such as an ASIC and an FPGA.

The operation unit I/F 115 connects the operation unit 116 including a display unit such as a touch panel and a hardware key and the control unit 110. The operation unit 116 presents information to the user, or detects an input from the user. The reader I/F 117 connects the reader 118 such as a scanner and the control unit 110. The reader 118 reads an image of a document, and the CPU 111 converts the image into image data such as binary data. The image data generated based on the image read by the reader 118 may be transmitted to an external apparatus or printed on a recording sheet. The print unit I/F 119 connects the print unit 120 such as a printer and the control unit 110. The CPU 111 transfers image data (print data) stored in the RAM 113 to the print unit 120 via the print unit I/F 119. The print unit 120 prints an image based on the transferred image data onto a recording sheet fed from a sheet feed cassette.

The wireless communication unit I/F 121 is an I/F for controlling the wireless communication unit 122, and connects the control unit 110 to an external wireless device (here, the mobile terminal 200) wirelessly. The control unit 110 is connected to a public line network 107 by controlling the FAX communication unit 124 such as a facsimile by the FAX unit I/F 123. The FAX unit I/F 123 is an I/F for controlling the FAX communication unit 124, and can perform connection to the public line network, control of a facsimile communication protocol, and the like by controlling a facsimile communication modem or an NCU.

The communication unit I/F 125 connects the control unit 110 and the network 100. In the communication unit I/F 125, the communication unit 126 transmits image data and various types of information inside the apparatus to an external apparatus on the network 100, and receives print data and information on the network 100 from an information processing apparatus on the network 100. As a method of transmission and reception via the network 100, transmission and reception using electronic mail and file transmission using other protocols (e.g., FTP, SMB, WEBDAV, and the like) can be performed. Furthermore, image data and various setting data can be transmitted and received through the network 100 by access from the mobile terminal 200, the message app server 300, and the icon generation AI server 400 through HTTP communication.

### <Hardware Configuration of Mobile Terminal>

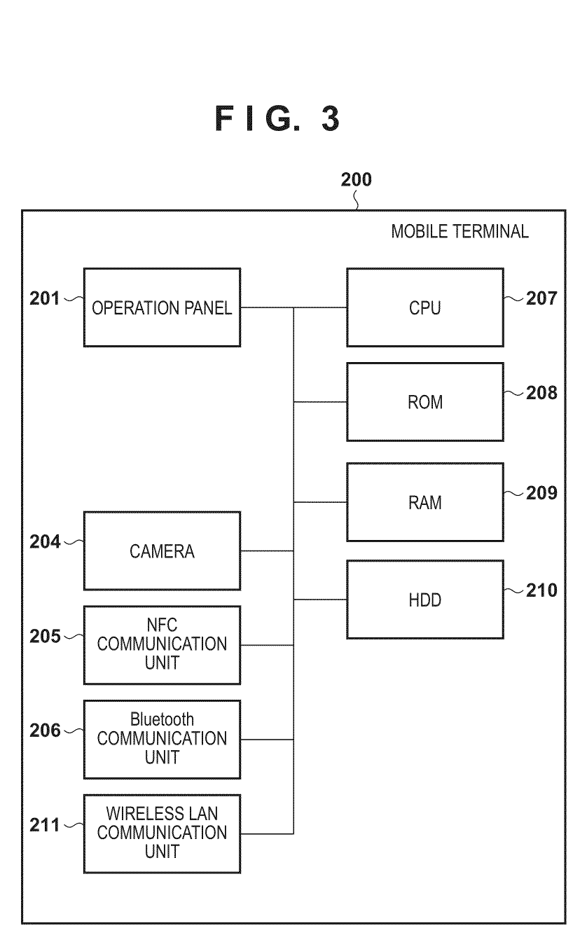

An example of the hardware configuration of the mobile terminal 200 according to the present embodiment will be described with reference to FIG. 3. Note that the mobile terminal 200 of the present embodiment is assumed to be an apparatus such as a smartphone or a tablet PC, but may be another apparatus as long as it is an information processing apparatus that can perform Wi-Fi communication. The mobile terminal 200 includes an operation panel 201, a camera 204, an NFC communication unit 205, a Bluetooth communication unit 206, a CPU 207, a ROM 208, a RAM 209, an HDD 210, and a wireless LAN communication unit 211.

The CPU 207 reads a control program stored in the ROM 208 to execute various processes for controlling the operation of the mobile terminal 200. The ROM 208 stores a control program. The RAM 209 is used as a main memory for the CPU 207 or a temporary storage area such as a work area. An HDD 210 stores various data such as photographs, electronic documents, or the like.

The operation panel 201 has a touch panel function that can detect a touch operation by the user, and displays various screens provided by the OS or an e-mail transmission application. The operation panel 201 is used to confirm information stored in the message app server 300. The user can input a desired operation instruction to the mobile terminal 200 by inputting a touch operation to the operation panel 201. Note that the mobile terminal 200 includes a hardware key (not illustrated), and the user can input an operation instruction to the mobile terminal 200 using this hardware key.

The camera 204 captures an image in response to a capturing instruction by the user. The image captured by the camera 204 is stored in a predetermined area in the HDD 210. It is also possible to acquire information from a QR code (registered trademark) read by the camera 204 using a program that can analyze the QR code.

The mobile terminal 200 can exchange data with various peripheral devices via the NFC communication unit 205, the Bluetooth (registered trademark) communication unit 206, and the wireless LAN communication unit 211. The Bluetooth communication unit 206 may be compatible with Bluetooth (registered trademark) Low Energy.

### <Hardware Configuration of Message App Server>

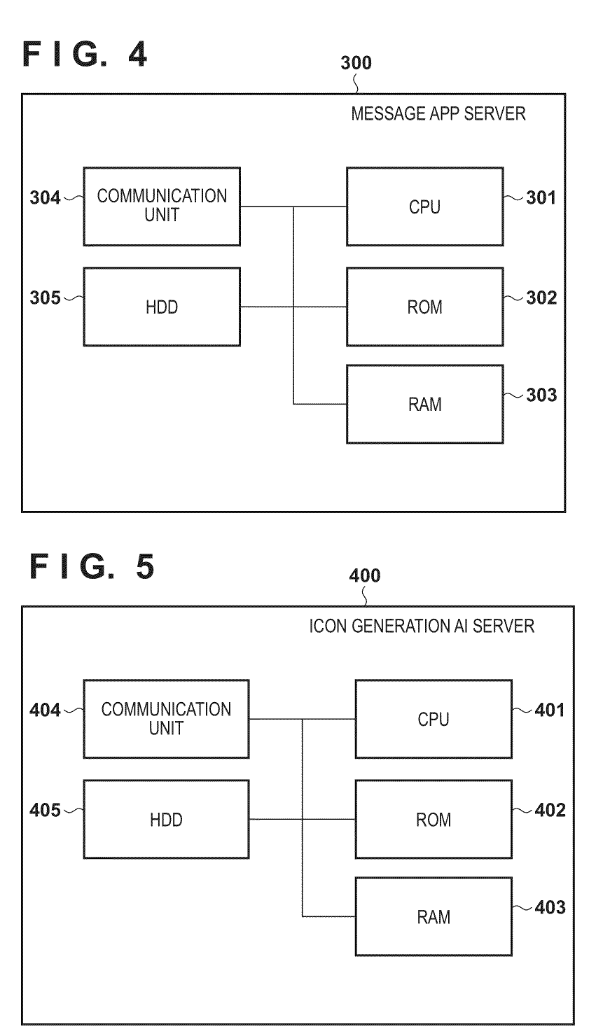

An example of the hardware configuration of the message app server 300 according to the present embodiment will be described with reference to FIG. 4. The message app server 300 includes a CPU 301, a ROM 302, a RAM 303, a communication unit 304, and an HDD 305.

The CPU 301 reads a control program stored in the ROM 302 to execute various processes for controlling the operation of the message app server 300. The ROM 302 stores a control program. The RAM 303 is used as a main memory for the CPU 301 or a temporary storage area such as a work area. The HDD 305 stores various data such as a message, image data, and channel information. Data can be transmitted and received to and from various devices such as the mobile terminal 200 and the MFP 101 via the communication unit 304. Note that the communication unit 304 may perform wired communication using Ethernet (registered trademark) or may perform wireless communication such as Wi-Fi.

### <Hardware Configuration of Icon Generation AI Server>

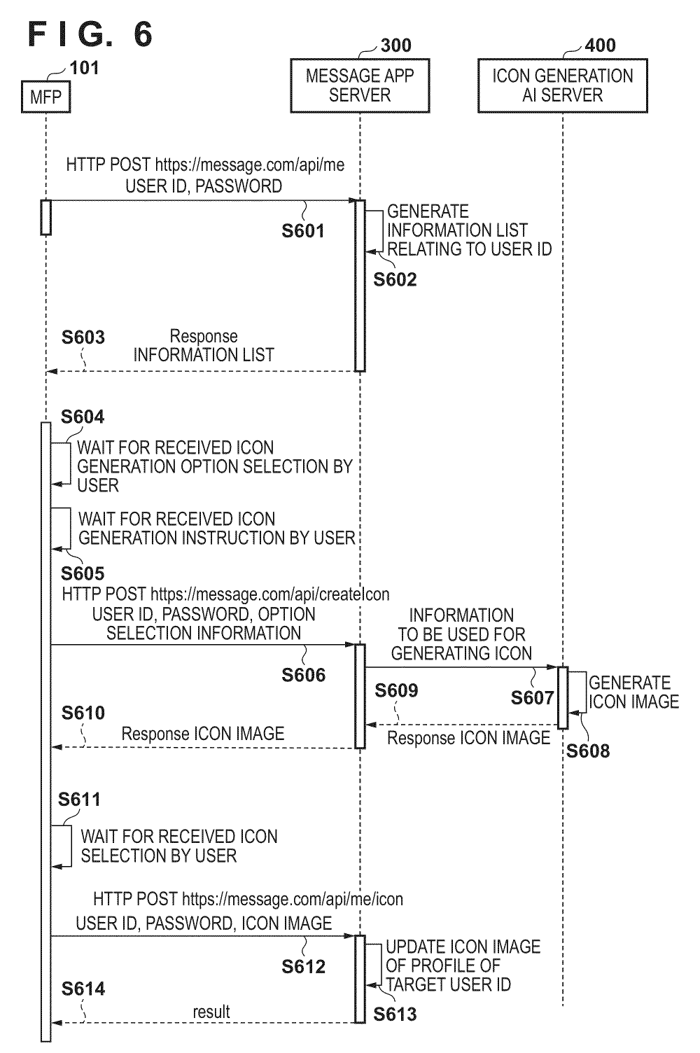

An example of the hardware configuration of the icon generation AI server 400 according to the present embodiment will be described with reference to FIG. 5. The icon generation AI server 400 includes a CPU 401, a ROM 402, a RAM 403, a communication unit 404, and an HDD 405.

The CPU 401 reads a control program stored in the ROM 402 to execute various processes for controlling the operation of the icon generation AI server. The ROM 402 stores a control program. The RAM 403 is used as a main memory for the CPU 401 or a temporary storage area such as a work area. The HDD 405 stores various data such as image data. Data can be transmitted and received to and from each device such as the mobile terminal 200, the MFP 101, and the message app server 300 via the communication unit 404.

### <Sequence>

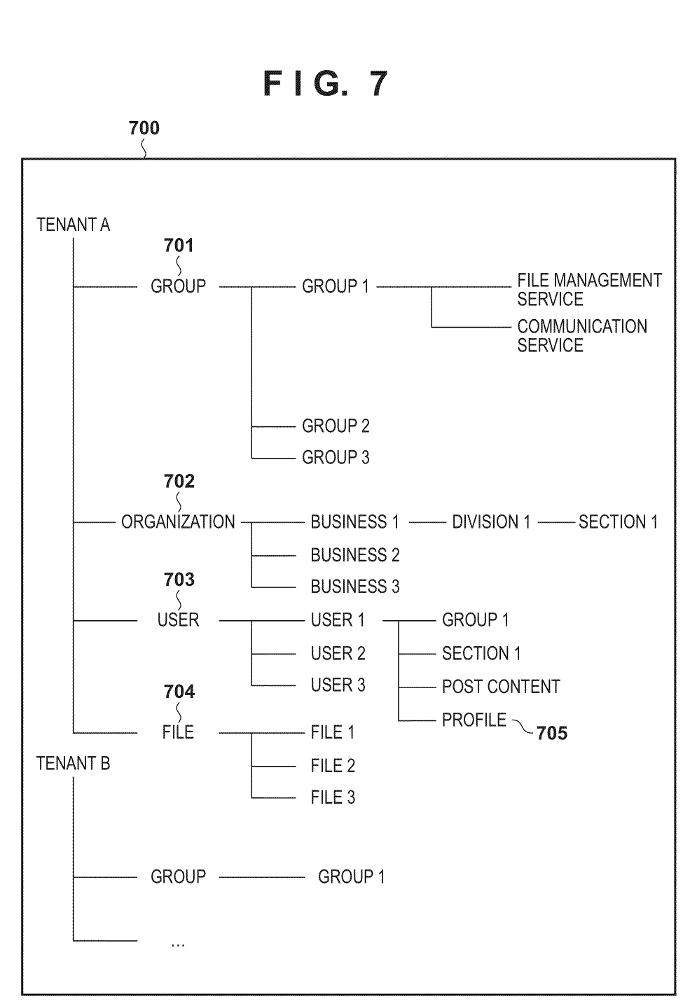

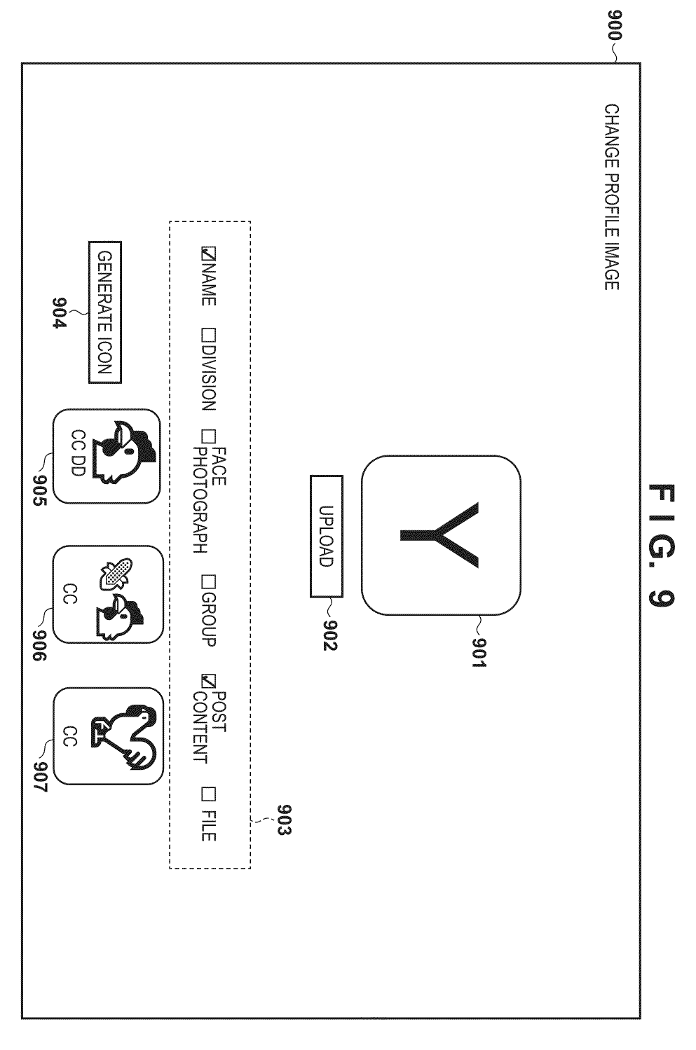

An example of the sequence of the system according to the present embodiment will be described with reference to FIG. 6. Here, a sequence in which the MFP 101 displays an icon generation UI and transmits an icon generation request to the message app server 300 will be described. The sequence of FIG. 6 is started as the screen illustrated in FIG. 9 described later is displayed on the operation unit 116. Here, a sequence realized among the MFP 101, the message app server 300, and the icon generation AI server 400 will be described. Note that the message app server 300 and the icon generation AI server 400 may be provided integrally, and in that case, the sequence is realized between the MFP 101 and the integrated server. The MFP 101 is an example of an information processing apparatus, but may be performed by an information processing apparatus such as the mobile terminal 200 or a PC in place of the MFP 101. In that case, the process of the MFP 101 described below may be executed via a printer driver of the MFP 101.

In S601, the CPU 111 of the MFP 101 controls the communication unit 126 to perform an acquisition request for an information list of the user by HTTP communication to the message app server 300. Specifically, the communication unit 126 transmits, to the message app server 300, a user ID and a password (user identification information) that have been input by the MFP 101, and information indicative of requesting the information list of the user. Here, an example of a command to be transmitted is "HTTP GET https://message.com/api/me". The URL "https://message.com/api/me" described in this command is a URL for accessing the message app server 300. By transmitting the user ID and the password to this URL, the message app server 300 searches tenant information for the information list corresponding to the user ID. Note that the user ID and the password may be input from the user via the operation unit 116 of the MFP 101.

In S602, the CPU 301 of the message app server 300 searches the HDD 305 for the information list corresponding to the user ID with reference to the user ID and password information received via the communication unit 304. Here, the information list indicates profile information including a name, a division, a group, and an icon image of the user. Subsequently, in S603, the CPU 301 controls the communication unit 304 and transmits the information list to the MFP 101 as response information of HTTP communication.

In S604, the CPU 111 of the MFP 101 receives icon generation option selection via the operation unit 116. Subsequently, in S605, the CPU 111 receives an icon generation instruction via the operation unit 116. Furthermore, in S606, the CPU 111 controls the communication unit 126 to transmit an icon image generation request to the message app server 300 by HTTP communication. Specifically, the communication unit 126 transmits, to the message app server 300, information indicative of requesting icon image generation with the user ID and password input by the MFP 101 and the option selection information selected in S604 as input. Here, an example of a command to be transmitted is "HTTP GET https://message.com/api/createIcon". The URL "https://message.com/api/createIcon" described in this command is a URL for accessing the message app server 300. By transmitting the user ID, the password, and the option selection information to this URL, the message app server 300 specifies information associated with the option selection information from the tenant information, and gives the icon generation AI server 400 an icon generation instruction.

In S607, the CPU 301 of the message app server 300 refers to the user ID, the password, and the option selection information received via the communication unit 304. What corresponds to information to be used for generating an icon selected as an option in the information list corresponding to the user ID is searched in the HDD 305. Here, the information to be used for generating an icon indicates profile information including a name, a division, a group, and an icon image of the user. Information to be used for generating an icon is transmitted to the icon generation AI server 400, and an icon image generation instruction is given.

In S608, the CPU 401 of the icon generation AI server 400 generates an icon image with reference to the information to be used for generating the icon received via the communication unit 404. Here, the icon image generation may use a process based on static logic or an image generation AI that generates an image based on input of text or image. Midjourny (https://www.midjourney.com/home/) is known as an AI automatic image generation service using an image generation AI model. Subsequently, in S609, the CPU 401 controls the communication unit 404, and transmits the icon image to the message app server 300 as response information of HTTP communication.

In S610, the CPU 301 of the message app server 300 controls the communication unit 304, and transmits the icon image to the MFP 101 as response information of HTTP communication. The process from S606 to S610 may be repeated N times by executing S605. An example of a screen executed three times is illustrated on the icon selection screen of FIG. 9.

In S611, the CPU 111 of the MFP 101 receives an icon selection instruction via the operation unit 116. Subsequently, in S612, the CPU 111 controls the communication unit 126 to transmit an icon image registration request to the message app server 300 by HTTP communication. The communication unit 126 transmits, to the message app server 300, the user ID and password input by the MFP 101, the icon image selected in S611, and information indicative of requesting registration of the icon image as an icon image of the profile information of the user ID. Here, an example of a command to be transmitted is "HTTP GET https://message.com/api/me/icon". The URL "https://message.com/api/me/icon" described in this command is a URL for accessing the message app server 300.

In S613, the CPU 301 of the message app server 300 stores, in the HDD 305, the icon image received via the communication unit 304, as the icon image of the profile information of the user ID. Subsequently, in S614, the CPU 301 controls the communication unit 304, and transmits an icon image update result to the MFP 101 as response information of HTTP communication, and ends the present sequence.

### <Data configuration of Tenant Information>

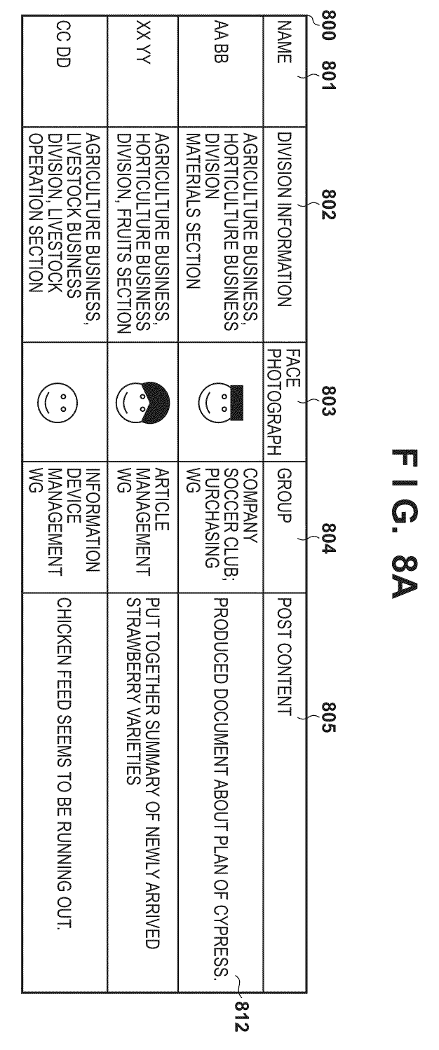

The data configuration of tenant information to be stored in the HDD 305 of the message app server 300 according to the present embodiment will be described with reference to FIG. 7. 700 indicates a data configuration of the tenant information to be stored in the message app server 300. The tenant information 700 includes information on a tenant A and a tenant B, as an example. The tenant information 700 is configured to include data of a group 701, an organization 702, a user 703, and a file 704 for each piece of tenant information.

The group 701 indicates a group that performs a job in the tenant. Specifically, it is possible to create a group corresponding to a specific job type such as an article management WG. The organization 702 indicates an organization configuration in the tenant. In the organization 702, departments are arranged in a tree in units such as businesses, divisions, and sections. The user 703 indicates each piece of user information. The user 703 includes a group and a department to which the user belongs, post content made by the user on a communication tool, and a profile 705. The profile 705 includes a name, a mail address, a telephone number, and an icon image. The file 704 includes file information existing in the tenant. The file 704 includes documents uploaded by the user with an information processing terminal and uploaded by a scan function of a multifunction peripheral.

### <Generation Method of Icon Image>

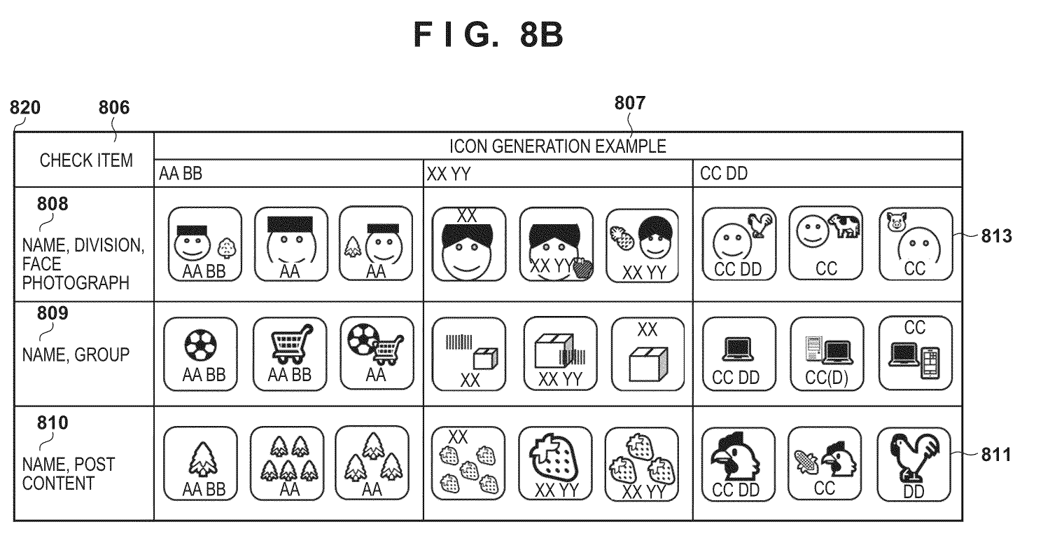

A generation method of icon image generation S608 to be executed with the CPU 401 by the icon generation AI server 400 according to the present embodiment will be described with reference to FIG. 8A and 8B. Note that the generation method of an icon image described below may be performed by a process based on static logic or may be performed using an image generation AI that generates an image based on input of text or image, as described above. FIG. 8A illustrates icons to be generated based on the information on a parameter table 800, and FIG. 8B illustrates a table 820 of icon generation examples.

The parameter table 800 includes, for each icon, information on a name 801, division information 802, a face photograph 803, a group 804, and post content 805. The user can generate an icon image by selecting one or more pieces of information included in the tenant information. These pieces of information correspond to data of the tenant information 700 stored in the HDD 305 of the message app server 300. The name 801 is stored in the profile 705. The division information 802 is stored in the organization 702. The face photograph 803 is stored in the profile 705. The group 804 is stored in the group 701. The post content 805 is information on the user 703 and is stored in the post content. Each row 812 indicates a parameter set of the name 801, the division information 802, the face photograph 803, the group 804, and the post content 805. For example, it can be read from the parameter that the user named "Ichiro Shimomaruko (In the figure, the name “Ichiro Shimomaruko” is abbreviated as “AA BB”)" belongs to the materials section and belongs to a company soccer club and a purchasing WG. Note that here, the information on the name 801, the division information 802, the face photograph 803, the group 804, and the post content 805 has been described as an example of the parameter relating to the user, but there is no intention to limit the technology of the present disclosure. For example, a parameter may include at least two of the name relating to the corresponding user, the affiliation to which the user belongs, an image of the user, and post content posted with a communication tool by the user. Furthermore, a document relating to the user may be included as a parameter.

A check item 806 in the table 820 indicates option selection information that the MFP 101 transmits to the message app server 300 in S606. An icon generation example 807 indicates an icon image example generated based on the check item 806. 808 indicates a case where an icon is generated based on the name 801, the division information 802, and the face photograph 803. For example, 813 indicates generated icon images of Saburo Yako (In the figure, the name “Saburo Yako” is abbreviated as “CC DD.”), and icons with pictures of a chicken, a cow, and a pig are generated under the influence of the word livestock operation section. 810 indicates a case where icon generation is performed based on the name 801 and the post content 805 as the check item. For example, 811 indicates generated icon images of Saburo Yako (CC DD), and icons with pictures of a chicken are generated from the post content about chicken feed, and icons more suitable for recognizing Saburo Yako (CC DD) are generated. Thus, the user can easily perform icon image generation by freely selecting tenant information for generating an icon expressing the feature of the user.

### <Icon Generation UI>

A screen example of the icon generation UI displayed on the operation unit 116 of the MFP 101 according to the present embodiment will be described with reference to FIG. 9. An icon generation UI 900 is displayed on the operation unit 116 of the MFP 101, but may be displayed on an external apparatus such as the mobile terminal 200 or a PC. When displayed on the external apparatus, it is displayed on the printer driver of the MFP 101.

The icon generation UI 900 is an example of a user interface, and is configured to include, as display objects, an icon image 901, an upload button 902, option selection information 903, an icon generation button 904, and icon image generation results 905 to 907. The current icon image 901 of "Saburo Yako (CC DD)" is an icon based on the Romanized initial "Y" of Yako (CC). The icon can also be registered by uploading a photograph or an existing image file by operation of the upload button 902. For example, a pop-up screen for selecting a file or an image is displayed by operating the upload button 902, and the user can select data to be used for the icon image from the file or the image stored in advance.

The option selection information 903 is an example of the first display object, and indicates, with check boxes, selection items corresponding to the parameter set included in the tenant information 700. One or more parameters that are checked are selected as options. When the icon generation button 904 is operated in a state where the option selection information 903 is selected, icon image generation corresponding to the option selection information 903 is executed, and the icon image generation results 905, 906, and 907 are displayed. The icon generation button 904 is an example of the second display object. At this time, if there is no icon image desired by the user, by re-selecting the parameter of the option selection information 903 to operate the icon generation button 904 again, it is possible to execute the icon image generation again and acquire another icon image result. Among the icon image generation results 905, 906, and 907, one operated by the user is registered as an icon image in the message app server 300, and the display of the current icon image 901 is updated to the icon image generation result selected by the user.

Note that a previously generated icon image generation result may be selectably displayed in a margin area of the icon generation UI 900. Such display is an example of the third display object. For example, there is a margin area in the right area of the icon generation UI 900, and the previously generated icon image generation result may be displayed in the area. If the number of previously generated icon images exceeds the number of the areas, they may be displayed together with scroll buttons, and non-displayed icons may be referred to by selecting the scroll buttons. By this, the user does not need to re-select a previously generated parameter to generate an icon, and can select an icon image including a previously generated icon image. A previously generated icon image group may be saved, and a display object for reading the saved data may be displayed in the margin area. In this case, when the display object is selected, corresponding saved data is displayed as an icon image generation result. Note that one of the generated icon images may be used as the display object. For example, the icon image generation result 905 may be selectably displayed as a display object in a margin area, and when the display object is selected, the icon image generation results 905, 906, and 907 may be displayed again. This enables the user to use a previously generated icon image without selecting and generating the parameter again. It is desirable that these saved data are deleted from the storage area together with end of the display of the icon generation UI 900. This can control consumption of a memory resource.

### <Generation Procedure of Icon Image>

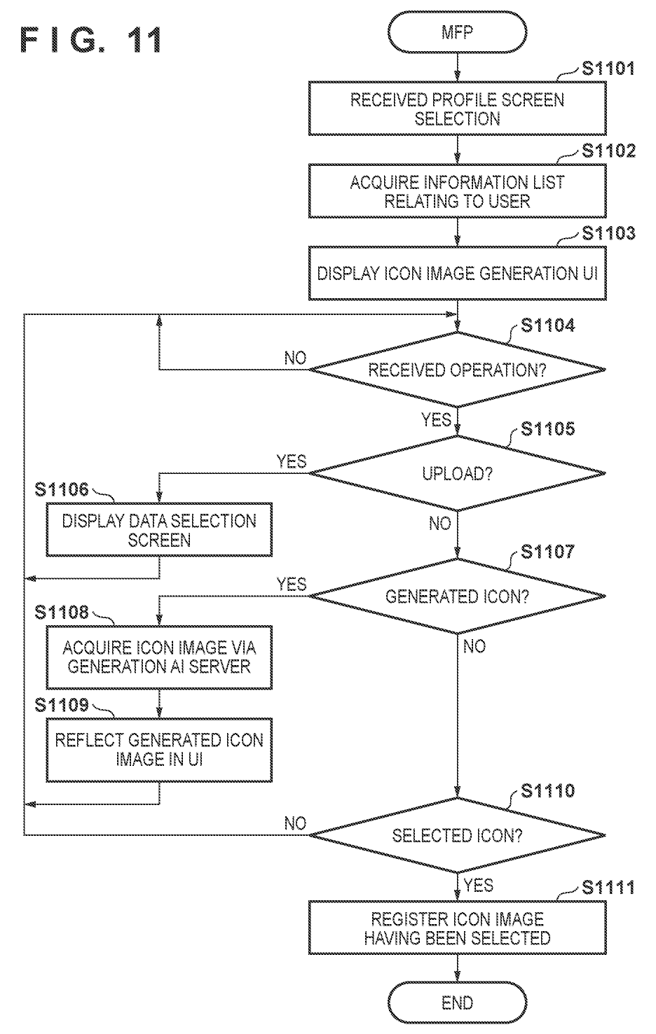

A process procedure of icon image generation in the MFP 101 according to the present embodiment will be described with reference to FIG. 11. The process described below is realized, for example, by the CPU 111 reading a program stored in the ROM 112 or the storage 114 into the RAM 113 and executing the program. Note that the process described below may be executed by a mobile terminal, a PC, or the like that activates the printer driver of the MFP 101 in place of the MFP 101.

In S1101, the CPU 111 receives a user input corresponding to screen transition to a profile screen on the screen displayed on the operation unit 116 of the MFP 101. Subsequently, in S1102, the CPU 111 functions as a first acquisition unit, requests the message app server 300 for an information list relating to the user, and acquires the information list. Here, the request described above includes the user ID and the password thereof in addition to the information indicating the request for the information list. Based on these pieces of information, the message app server 300 transmits, to the MFP 101, the information list of the corresponding user from held information. In S1103, the CPU 111 functions as a display control unit, and displays the icon generation UI 900 on the operation unit 116, which is a display unit, in accordance with the information list acquired in S1102. Here, the information list includes at least two parameters of the plurality of parameters, for example, the name relating to the corresponding user, the affiliation to which the user belongs, the image of the user, and the post content posted with the communication tool by the user. Furthermore, a document relating to the user may be selectable as a parameter.

In S1104, the CPU 111 determines whether the user input has been received via the icon generation UI 900. When the user input has been received, the process proceeds to S1105, and when the request has not been received, the determination in S1104 is repeated. In S1105, the CPU 111 determines whether the upload button 902 has been operated. When the operation has been performed, the process proceeds to S1106, and otherwise, the process proceeds to S1107. In S1106, the CPU 111 displays a data selection screen (not illustrated) on which a file or an image are selectable as a pop-up screen on the icon generation UI 900, and returns the process to S1104.

On the other hand, in S1107, the CPU 111 determines whether the icon generation button 904 has been operated. When the operation has been performed, the process proceeds to S1108, and otherwise, the process proceeds to S1110. In S1108, the CPU 111 functions as a second acquisition unit, and transmits the selected parameter to the icon generation AI server 400 to acquire one or more icon images. Subsequently, in S1109, the CPU 111 functions as a presentation unit, selectably presents the one or more generated icon images (e.g., the icon image generation result 905 to 907) to the icon generation UI 900, and returns the process to S1104.

On the other hand, in S1110, the CPU 111 determines whether an icon image has been selected via the icon generation UI 900. When the icon image has been selected, the process proceeds to S1111, and otherwise, the process returns to S1104. Here, the selection of the icon image includes two types of cases, i.e., a case where any of the one or more generated icon images has been selected and a case where the selection is performed via the data selection screen displayed in S1106. In S1111, the CPU 111 functions as a registration unit, registers the selected icon image, and updates the icon image 901 to end the process of the present flowchart.

### <Usage Example of Icon Image>

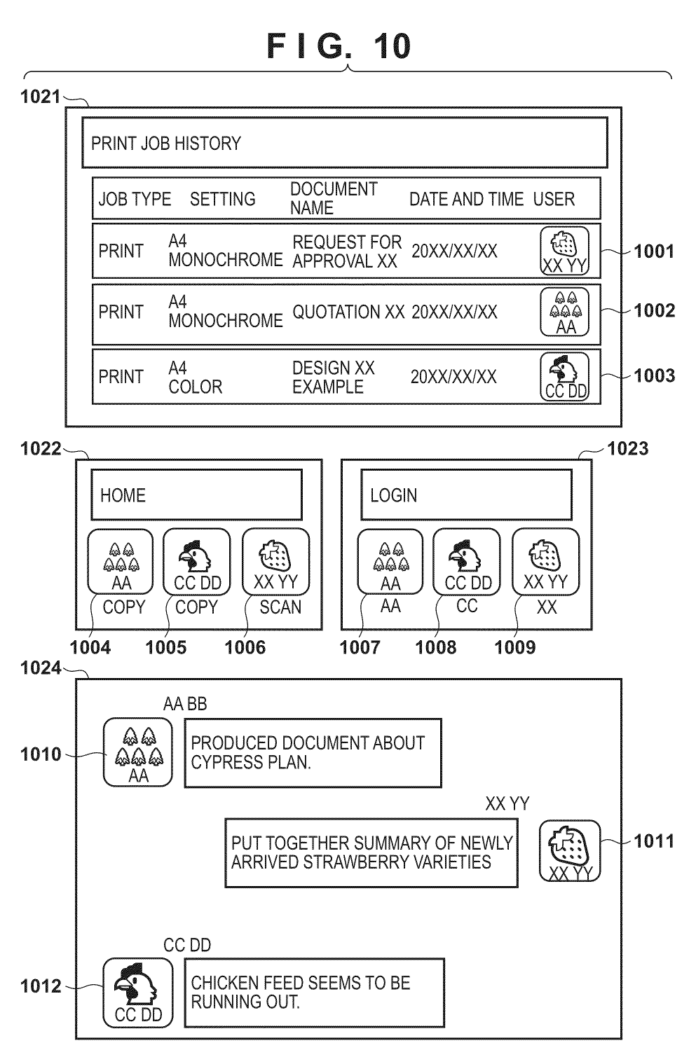

A usage example of a generated icon image according to the present embodiment will be described with reference to FIG. 10. FIG. 10 illustrates a print job history screen 1021, a home screen 1022, a login screen 1023, and a post screen 1024 as usage examples of registered icon images.

The print job history screen 1021 is a screen indicating a history of previously executed print jobs. On the print job history screen 1021, it is possible to easily recognize who has printed the job only by referring to icon images 1001, 1002, and 1003. Therefore, the target can be easily identified also when the job is executed again from the job history. The association between an icon image and a user is registered in association with the user who has logged in to the MFP 101 and has given the instruction for the icon generation. When the user whose icon has been registered gives an instruction for copy or scan in a state of logging in to the MFP 101 and executes the job, the history of the job and the icon of the user who has given the execution instruction for the job are stored in association with each other.

The home screen 1022 can provide, in such a manner that the user easily identifies, job execution buttons having settings customized for respective users such as a copy button 1004 of "Ichiro Shimomaruko (In the figure, the name “Ichiro Shimomaruko” is abbreviated as “AA BB.”)", a copy button 1005 of "Saburo Yako (In the figure, the name “Saburo Yako” is abbreviated as “CC DD.”)", and a scan button 1006 of "Jiro Toride (In the figure, the name “Jiro Toride” is abbreviated as “XX YY.”)". A simple login screen that allows login only by touching the user's icon selectably displays an icon image 1007 of "Ichiro Shimomaruko (AA BB)", an icon image 1008 of "Saburo Yako (CC DD)", and an icon image 1009 of "Jiro Toride (XX YY)". Just by touching any of these icon images, the user can log in to the MFP 101 as the corresponding user. The icon on the login screen 1023 is an icon displayed by turning on a simple login function. Normally, login is performed by receiving input of the ID and the password for logging in to the MFP 101 from the user, but when the simple login function is on, the user who logs in can be identified while omitting the input of the ID and the password. For example, when the icon of "Yako (CC)" is selected, "Yako (CC)" is brought into a state of being logged in to the MFP, and usable functions are limited in accordance with a role registered in association with "Yako (CC)". When a job is executed in that state, the job history and the user information of "Yako (CC)" are stored in association with each other. The post screen 1024 in the communication tool uses an icon image for easily identifying who is posting, as indicated by 1010, 1011, and 1012.

As described above, the information processing apparatus according to the present embodiment acquires an information list including a plurality of parameters relating to a user, and displays, on a display unit, a user interface for generating an icon image that identifies a user. The present information processing apparatus selects one or more parameters of a plurality of parameters in accordance with the user input via the user interface, and transmits the one or more selected parameters to an external server to acquire one or more icon images. Furthermore, the present information processing apparatus presents the one or more acquired icon images on the user interface. According to the present embodiment, using information relating to the user on the message app server 300, it is possible to create, by a simple operation, an arbitrary icon image that can identify the user. Note that the present embodiment is an example, and the process of the sequence of FIG. 6 may be performed by the message app server 300 alone. The icon generation AI server 400 may be implemented as a function of the message app server 300. Furthermore, in place of the MFP 101, a mobile terminal, a PC, or the like may implement the flowchart of FIG. 11. In this case, the process may be performed in the process of the printer driver activated in each apparatus.

According to the technology of the present disclosure, a novel mechanism that easily generates an icon image relating to a user can be provided.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-144466, filed August 26, 2024, which is hereby incorporated by reference herein in its entirety.

WHAT IS CLAIMED IS:

1. An information processing apparatus comprising:
one or more memory devices that store a set of instructions; and
one or more processors that execute the set of instructions to:
acquire an information list including a plurality of parameters relating to a user;
display, on a display unit, a user interface for generating an icon image that identifies a user;
select one or more parameters of the plurality of parameters in accordance with a user input via the user interface;
transmit the one or more selected parameters to an external server to acquire one or more icon images; and
present the one or more acquired icon images to the user interface.

2. The information processing apparatus according to claim 1, wherein
the one or more processors execute instructions in the one or more memory devices to: register the selected icon images in accordance with a user input via the user interface.

3. The information processing apparatus according to claim 2, wherein
the one or more processors execute instructions in the one or more memory devices to: transmit identification information of the user to an external server to acquire the information list.

4. The information processing apparatus according to claim 2, wherein
the user interface includes a first display object that can respectively select the plurality of parameters, and a second display object that instructs generation of an icon image by using one or more selected parameters.

5. The information processing apparatus according to claim 4, wherein
the user interface further includes a third display object for selecting previously generated icon images.

6. The information processing apparatus according to claim 5, wherein
the third display object is a display object that can respectively select the previously generated icon images.

7. The information processing apparatus according to claim 5, wherein
the third display object is a display object for presenting one or more icon images for each previously executed generation.

8. The information processing apparatus according to claim 2, wherein
the plurality of parameters include at least two parameters of a name relating to a corresponding user, an affiliation to which the user belongs, an image of the user, a post content posted with a communication tool by the user, and a document relating to the user.

9. The information processing apparatus according to claim 2, wherein
the information processing apparatus is an image forming apparatus that forms an image, and
the one or more processors execute instructions in the one or more memory devices to: display a registered icon image of a predetermined user in an item relating to the predetermined user on a screen of the image forming apparatus.

10. The information processing apparatus according to claim 9, wherein
the screen of the image forming apparatus includes at least one of a home screen, a login screen, a print job history screen, and a post screen.

11. The information processing apparatus according to claim 2, wherein
the information processing apparatus is a mobile terminal that executes a printer driver of an image forming apparatus, and
the one or more processors execute instructions in the one or more memory devices to: display the user interface on a screen of the printer driver.

12. A control method of an information processing apparatus, the control method comprising:
acquiring an information list including a plurality of parameters relating to a user;
displaying, on a display unit, a user interface for generating an icon image that identifies a user;
selecting one or more parameters of the plurality of parameters in accordance with a user input via the user interface;
transmitting the one or more selected parameters to an external server to acquire one or more icon images; and
presenting the one or more acquired icon images to the user interface.

13. A non-transitory computer-readable storage medium storing a computer program for causing a computer to execute each process in a control method of an information processing apparatus, the control method comprising:
acquiring an information list including a plurality of parameters relating to a user;
displaying, on a display unit, a user interface for generating an icon image that identifies a user;
selecting one or more parameters of the plurality of parameters in accordance with a user input via the user interface;
transmitting the one or more selected parameters to an external server to acquire one or more icon images; and
presenting the one or more acquired icon images to the user interface.
